(19) United States
(12) Patent Application Publication
(10) Pub. No.: US 2003/0133563 A1
(43) Pub. Date: Jul. 17, 2003

(54) Communications and control arrangement and operating method for said arrangement

(76) Inventor: Thomas Plarre, Holzkirchen (DE)

Correspondence Address: Kevin R. Spivak, Morrison & Foerster LLP, Suite 300, 1650 Tysons Boulevard, McLean, VA, 22102, US

(21) Appl. No.: 10/324,065

(22) Filed: Dec. 20, 2002

(30) Foreign Application Priority Data
Dec. 20, 2001 (DE) 10162984.2

(51) Int. Cl. H04M 3/00; H04M 5/00

(52) U.S. Cl. 379/265.01

(57) ABSTRACT

A communications and control arrangement of a call center, whereby a speech recognition unit is provided centrally in the telecommunications system and/or in each case locally in the data terminal devices of the agent workstations, and a process control unit connected to and interacting with the local or central speech recognition unit and the announcement unit is provided in each case in the data terminal devices.

### CLAIM FOR PRIORITY

This application claims priority to Application No. 10162984.2 which was filed in the German language on Dec. 20, 2001.

### TECHNICAL FIELD OF THE INVENTION

The invention relates to a communication and control method and arrangement, and in particular, to a call center having workstations and terminal devices.

### BACKGROUND OF THE INVENTION

Call centers are becoming increasingly important, particularly due to the forecast growth in the e-commerce domain. The call time during which an agent speaks in person to a customer is one of the most expensive factors. However, the person-to-person call will remain an important factor in customer support and services provided by a call center for a customer.

Everything which supports the call center agent, in the prompt performance of its tasks during the call with the customer, results in cost savings for the call center operator.

A typical call center configuration is shown in FIG. 1. The core component is a telecommunications system to which various further components are connected via a local area network LAN. This may be either a private branch exchange (PBX) or a public switching office with call center functionality. The agent workstations A1, A2 are connected to the telecommunications system. These may be PC workstations with a direct telecommunications system network connection (e.g. ISDN card) or workstations with a PC and a separate communications system terminal. In order to enable computer telephony integration (CTI), a “CTI server” can also be connected to the telecommunications system.

Web servers and e-mail/fax/SMS servers complete the call center in order to be able to respond efficiently to customer inquiries or to provide services via other media also. These components are irrelevant to the explanation of the invention and will therefore not be examined more closely below.

An automatic announcement unit AE is also normally used for voice services in the call center. This announcement unit can automatically provide a customer with information (e.g. by announcing a telephone number in the directory inquiries service), but may also independently obtain information from the customer. This is normally done by means of an automatic dialogue with the customer. The customer's information is recorded via speech recognition or DTMF signals. It may be used by the telecommunications system or by a call center agent who takes over the further processing of the call.

In practice, the automatic dialogues are usually highly complicated. If the call center agent intervenes to continue the service provision, it frequently lacks the necessary information, which is counter-productive to the endeavor to reduce the actual call time. In some cases, the customer must provide information twice (to the automatic announcement unit and to the call center agent) in order that a service can be provided.

Conventional working methods hitherto employed to provide slightly more complex services by a call center are therefore neither sufficiently simple and user-friendly (and therefore attractive) for the customer nor adequately efficient and therefore economical for the operator.

### SUMMARY OF THE INVENTION

The invention provides a communications and control arrangement, and also a corresponding operating method for a call center, which enables increased efficiency by shortening the agent call times. The call center also simpler and has a user-friendly design of the customer contacts.

In one embodiment of the invention, there is a communications and control arrangement of a call center, with a telecommunications system, a plurality of agent workstations, each having a telecommunications terminal device and a data terminal device or a data terminal device additionally designed as a telecommunications terminal device, and an automatic announcement unit connected via a local area network to the agent workstations, wherein a speech recognition unit is provided centrally in the telecommunications system and/or in each case locally in the data terminal devices of the agent workstations, and a process control unit connected to and interacting with the local or central speech recognition unit and the announcement unit is provided in each case in the data terminal devices.

In one aspect of the invention, if the agent workstation is equipped with a speech recognition system and a system for automatic process control of the various services or sub-processes involved in the service provision, many processes can be automated for the call center agent, thereby shortening the agent's call time. The automatic process control uses, inter alia, information which is provided by the speech recognition system in directly processable form. The original speech information may originate either from the call center agent or from the customer.

The automatic process control can also use other information for control purposes. This may involve, in particular, information from the telecommunications system signaling or control information entered by the call center agent. The automatic process control therefore supports the call center agent in the performance of its tasks.

This combination of speech recognition and automatic process control can also be used not only for calls passed directly to an agent to perform a service, but also for calls in which information has already been gathered in advance via an automatic announcement unit. Even in the case of agent return connections and calls initiated by the agent (e.g. following a Web inquiry or marketing campaign), speech recognition can be used for automatic control of processes on the agent's workstation.

In a preferred embodiment, the process control units have agent-user interfaces which are independent from one another, and which enable intervention by the agent in functions of the telecommunications system and the automatic announcement unit, allowing the agent to control a service. The agent-user interfaces are adapted on the hardware and software side to the working processes of a call center agent, enabling the latter to intervene quickly and efficiently, for example, in a dialogue with a customer which began as an automatic process or the automatic implementation of a service in the event of problems or specific customer requests. Speech input and processing means can be implemented as well as special control keypads or touch-sensitive display screens or panels or the like.

Furthermore, it is preferable to make provision for the process control units in each case to have a customer-user interface which enables control of a service depending on control commands from a customer which are transferred via the telecommunications system. In particular, the customer-user interfaces are connected to the telecommunications system and are designed such that they respond to key inputs on customer terminal devices. Alternatively or additionally, the customer-user interfaces are connected to the speech recognition unit and are designed such that they respond to predefined speech commands.

The aforementioned customer-user interfaces enable the process control to respond to specific customer information, which is obtained, for example, during an automatic dialogue. Depending on this information, specific branches of the processes involved in the provision of a service can be implemented independently or with support, or by means of agent intervention requested via the process control. Particular user-friendliness and therefore extraordinarily high customer acceptance of the call center working processes can thus be achieved.

The agent-user interfaces and/or customer-user interfaces are appropriately implemented on the data terminal devices of the agent workstations, whereas, at the other end, the speech recognition unit and in particular also at least parts of the agent-user interfaces and customer-user interfaces are implemented on a speech recognition server in the local area network.

One advantage of the invention is the combination of agent-user interfaces implemented on the agents' individual data terminal devices and customer-user interfaces implemented on a central speech recognition server. Highly accurate and user-friendly speech recognition with a high resource requirement can thus be implemented in this combination at an acceptable cost per agent workstation. Through suitable multi-channel design (which is known to one having ordinary skill in the art), this can be used simultaneously for a conventionally required number of parallel existing connections. On the other hand, the implementation of the agent-user interfaces on the individual data terminal devices is already appropriate in that the terminal devices can be largely implemented in the context of standard MMIs.

It is also advantageous if the automatic announcement unit is connected via a control signal input to the agent-user interfaces and can be controlled via the latter. A speech synthesis unit can be provided between the agent-user interfaces and the announcement unit for conversion into speech output of control commands entered via control keys on the data terminal devices of the agent workstations and/or text retrieved from a memory. The mode of operation of the system unit can therefore also be designed in a significantly more flexible and therefore more customer-friendly manner compared with known systems and, in terms of impact on the customer, can largely approximate a call made entirely in person by the agent.

To complete the call center system, a CTI server and/or a Web server and/or an e-mail/fax/SMS server is furthermore preferably provided in the local area network, whereby the server(s) is/are connected via control signal inputs to the automatic process controls, and at least some of the server functions which are used for a service can be controlled from the agent workstations. More detailed processes of services which are provided using the aforementioned servers can also be controlled from the agent workstations, particularly also through manual intervention by the agents and/or in response to inputs from customers on their local terminal devices. This also substantially increases the flexibility and efficiency of the entire mode of operation of the call center.

### BRIEF DESCRIPTION OF THE DRAWINGS

The invention is described below with reference to the drawings, in which:

FIG. 1 illustrates a conventional call center configuration.

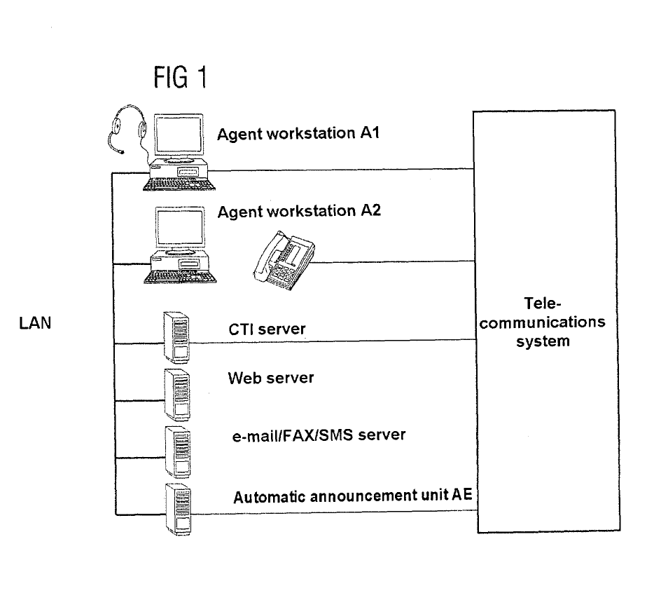

FIG. 2 illustrates a communications and control arrangement CCA of a call center in accordance with the invention.

### DETAILED DESCRIPTION OF THE INVENTION

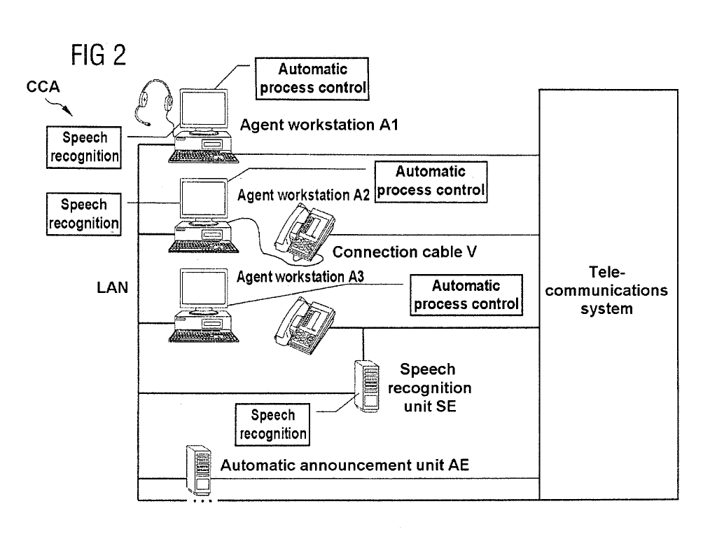

FIG. 2 shows, by way of a summary illustration, a communications and control arrangement CCA of a call center, whereby various types of agent workstations A1 to A3 are shown symbolically.

The agent workstation A1 is an integrated workstation, in which the speech recognition system and automatic process control are directly integrated. However, this workstation may also be a VoIP client, in which case the direct connection to the telecommunications system is eliminated.

The agent workstation A2 is a workstation with a PC and a telecommunications system terminal device. The telecommunications system terminal device and PC are connected via a suitable cable, so that the speech recognition system and automatic process control can be integrated on the agent's PC. The automatic process control may, for example, use a CTI server to control switching operations.

The agent workstation A3 is likewise equipped with a PC and a (separate) telecommunications system terminal device. The telecommunications system terminal device is connected to a separate speech recognition system.

The information from the speech recognition system originates from a speech recognition unit SE separately installed on a server and is made available via a LAN to the automatic process control on the agent's PC. This system could also perform the speech recognition for a plurality of agent workstations and could therefore also be directly connected to the telecommunications system.

The processes and improvements associated with the invention will be explained with reference to the following examples:

### EXAMPLE 1

A customer requires telephone number information and uses the call center service. After dialing the corresponding service number, the call is forwarded to the telecommunications system. Here, a suitable call center agent can be identified on the basis of different criteria (e.g. service number), and the call is forwarded to the agent workstation. If the agent accepts the call, the automatic process control can recognize from the service number that the customer would like telephone number information and presents a suitable application to the agent.

The call center agent currently requests, for example, information such as the name, town, country, etc. from the customer and enter this in the application to search for the required telephone number. These work steps can be automated. Through the integration of a speech recognition system, it is possible to obtain this information automatically and make it available to the automatic process control. The latter can enter the data in the appropriate fields of the application in order to search for telephone numbers. If speech recognition is not possible in parts of the communications process (e.g. due to the customer's poor pronunciation), this information can be instantly reprocessed by the call center agent.

If the customer wishes to be forwarded once the telephone number has been found, this information can also be obtained via the speech recognition system. The automatic process control can then initiate further required actions.

### EXAMPLE 2

A call center agent is conducting a telemarketing campaign. The agent is presented with data records from different customers who are to be interviewed on a specific subject. The call center agent calls the customer for this purpose. The customer is willing to answer the questions, and the agent asks the questions associated with the campaign. The answers are noted “manually” in the customer data record.

These work steps can be automated. Through the integration of a speech recognition system, the answers can be automatically recognized, made available to the automatic process control and stored in the appropriate fields in order to record the campaign data.

If the customer is not willing to answer the questions or does not wish to comment until a later time, this can also be automatically recognized by a speech recognition system. The information can be automatically noted in the customer data record and the data record is resubmitted the following day. The call center agent can immediately process the next data record.

Through the combination of the speech recognition system and automatic process control directly on the call center agent's workstation, the work processes can be simplified and speeded up for the agent. Depending on the service, either simple or differentiated speech recognition and process control will be required. Current speech recognition methods can already accurately recognize entire words, but speech recognition will also further improve in future and enable e.g. recognition and interpretation of sentences. Through the combination of speech recognition and process control on the agent workstation, more complex services can thus perspectively also be automated to support the call center agent.

As a result, the call center agent can perform its task more quickly. Through personal contact and prompt service provision, high customer friendliness with low operator costs can be expected.

What is claimed is:

1. A communications and control arrangement of a call center, with a telecommunications system, a plurality of agent workstations, each having a telecommunications terminal device and a data terminal device, and an automatic announcement unit connected via a local area network to the agent workstations, comprising:
a speech recognition unit provided centrally in the telecommunications system and/or locally in the data terminal devices of the agent workstations; and
a process control unit connected to and interacting with the local or central speech recognition unit and the announcement unit is provided in the data terminal devices.

2. The communications and control arrangement as claimed in claim 1, wherein the process control units have agent-user interfaces which are independent of one another and which enable intervention by the agent in functions of the telecommunications system and the automatic announcement unit, allowing the agent to control a service.

3. The communications and control arrangement as claimed in claim 1, wherein the process control units have a customer-user interface which enables control of a service depending on control commands from a customer transferred via the telecommunications system.

4. The communications and control arrangement as claimed in claim 3, wherein the customer-user interfaces are connected to the telecommunications system and are designed such that it responds to key inputs on customer terminal devices.

5. The communications and control arrangement as claimed in claim 3, wherein the customer-user interfaces are connected to the speech recognition unit and are designed such that it responds to predefined speech commands.

6. The communications and control arrangement as claimed in claim 2, wherein the agent-user interfaces and/or customer-user interfaces are implemented on the data terminal devices of the agent workstations.

7. The communications and control arrangement as claimed in claim 1, wherein the speech recognition unit and at least parts of the agent-user interfaces and customer-user interfaces are implemented on a speech recognition server in the local area network.

8. The communications and control arrangement as claimed in claim 2, wherein the automatic announcement unit is connected via a control signal input to the agent-user interfaces, via which it can be controlled.

9. The communications and control arrangement as claimed in claim 8, further comprising a speech synthesis unit inserted between the agent-user interfaces and the announcement unit to convert into speech output of control commands entered via control keys on the data terminal devices of the agent workstations and/or text retrieved from a memory.

10. The communications and control arrangement as claimed in claim 1, further comprising a server provided in the local area network, whereby the server is connected via control signal inputs to the automatic process controls, and at least some of the server functions used for a service can be controlled from the agent workstations.

11. An operating method of a call center which is set up with a telecommunications system, a plurality of agent workstations, each having a telecommunications terminal device, and a data terminal device, and an automatic announcement unit connected via a local area network to the agent workstations, comprising:
providing at least one service through interaction of one speech recognition unit provided centrally in the telecommunications system and/or a plurality of speech recognition units provided locally in the data terminal devices of the agent workstations; and
controlling distributed communication of the automatic announcement unit and the agent with a customer via a process control unit.

12. The operating method as claimed in claim 11, wherein the service includes intervention by the agents in functions of the telecommunications system and the automatic announcement unit.

13. The operating method as claimed in claim 11, wherein the service is provided depending on control commands from the customer which are transferred via the telecommunications system.

14. The communications and control arrangement as claimed in claim 10, wherein the server is a CTI server, Web server and/or an e-mail/fax/SMS server.
